(19) United States
(12) Patent Application Publication
(10) Pub. No.: US 2007/0099048 A1
(43) Pub. Date: May 3, 2007

(54) Fuel cell

(75) Inventors: Yoichi Takasu, Kawasaki (JP); Fumio Takei, Kawasaki (JP); Masami Tsutsumi, Kawasaki (JP); Hiroaki Yoshida, Kawasaki (JP); Kensuke Yoshida, Kawasaki (JP); Seiji Hibino, Kawasaki (JP); Makoto Yoshino, Kawasaki (JP); Takeo Kasajima, Kawasaki (JP); Shinichi Ueki, Shizuoka (JP); Takeshi Miyazaki, Shizuoka (JP); Osamu Terabayashi, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: FUJITSU LIMITED, Kawasaki (JP); FDK CORPORATION, Tokyo (JP)

(21) Appl. No.: 11/344,008

(22) Filed: Feb. 1, 2006

(30) Foreign Application Priority Data
Oct. 27, 2005 (JP) 2005-313251

(51) Int. Cl. H01M 8/04; H01M 8/10

(52) U.S. Cl. 429/26; 429/30; 429/22; 429/25

(57) ABSTRACT

A fuel cell includes an electric power generation part; the electric power generation part including an air electrode to which oxygen gas is supplied, a fuel electrode to which fuel gas is supplied, and a solid electrolyte layer having a proton conductivity and put between the air electrode and fuel electrode; a fuel storage part storing a liquid fuel; a liquid fuel vaporization film made of non-porous material and configured to vaporize the liquid fuel so as to supply fuel gas to the fuel electrode; and a gas fuel supply speed control plate provided between the liquid fuel vaporization film and the fuel electrode and configured to control a supply speed of the fuel gas to the fuel electrode. The gas fuel supply speed control plate includes a plurality of openings piercing between the liquid fuel vaporization film and the fuel electrode.

### BACKGROUND OF THE INVENTION

1. Field of the Invention

The present invention generally relates to fuel batteries, and more specifically, to a vaporized fuel supply type fuel cell having a small size and a proton conductive solid electrolyte layer.

2. Description of the Related Art

Recently, a portable electronic device, such as a portable phone, portable information terminal device, notebook type personal computer, or the like has been having multiple functions and high properties. It is required that a cell as a driving electric power source of such a portable electronic device have an improved property.

At present, a lithium ion secondary cell is mainly used for the portable electronic device. However, since dramatic improvement of energy density of the lithium ion secondary cell may not be expected, it is difficult for the lithium ion secondary cell to have a required energy density. In addition, the secondary cell is required to be charged and therefore is limited in usefulness.

A fuel cell is now being paid attention to as a driving electric power source because the fuel cell has high energy density and solves the limiting charging problem.

More specifically, attention is being paid to a direct methanol type fuel cell (hereinafter “DMFC”) as the driving electric power source of portable electronic devices. In theory, the DMFC has several times the capacity of a lithium ion cell having the same volume.

In the DMFC, polymer solid electrolyte is used as electrolyte, and an organic fuel such as methanol is directly supplied on an electrode so that electric power is generated. Since the DMFC does not use a modifier for modifying the organic fuel to hydrogen, it is easy to make the DMFC be small and light-weight. Hence, the DMFC is proper for the electric power source of the portable electric device.

In the DMFC, methanol is supplied from a liquid fuel storage part to a catalyst layer of a fuel electrode so that proton (H⁺), electron (e⁻) and carbon dioxide are generated (reaction formula:
CH₃OH+H₂O→CO₂+6H⁺+6e⁻).

Protons permeate a polymer solid electrolyte film and combine with the catalyst layer of an air electrode so that water is generated. In this case, the fuel electrode and the air electrode are connected with an outside circuit so that electric power can be taken out by generated electrons.

The DMFC is classified into an active type and a passive type. In the active type DMFC, an auxiliary device such as a pump is used to supply methanol as a fuel. In the passive type DMFC, methanol is supplied by a capillary force or natural diffusion.

Since the active type DMFC uses the auxiliary device for supplying the fuel, the active type DMFC is disadvantageous compared to the passive type DMFC from the view point of making the cell small. In addition, since an electric power is required for driving the auxiliary device, the active type DMFC is disadvantageous compared to the passive type DMFC from the view point of energy efficiency. Thus, for the use of the portable electronic device, the passive type DMFC which does not use the auxiliary device for supplying the fuel is more advantageous than the active type DMFC

A fuel supplying method for the passive fuel cell is classified into a liquid supply type and a vaporization supply type.

In the liquid supply type, a liquid state fuel is directly supplied on a surface of the fuel electrode. In the vaporization supply type, the liquid fuel is vaporized and then supplied to the electrode part. In the liquid supply type, if a methanol high density solution is used as fuel, the methanol high density solution permeates an electrolyte film so that methanol cross over happens, that is, methanol not contributing to electric power generation increases and a property of the air electrode is degraded.

On the other hand, in the vaporization supply type, since methanol gas is supplied to the fuel electrode, the methanol cross over can be avoided. As a result of this, in the vaporization supply type, it is possible to make the fuel supplied from inside the tank have a high density. In a case of the same volume, as compared with the case with a low density methanol aqueous solution, energy density is improved. In other words, in the case where the liquid fuel having the same volume is used, the vaporization supply type DMFC is better from the perspective of obtaining a fuel cell having a high energy density.

Meanwhile, a method whereby the methanol aqueous solution is vaporized by using a carbon porous plate is suggested as the vaporization supply type DMFC. See Japan Laid-Open Patent Application Publication No. 2000-106201. The methanol aqueous solution is transferred in pores of the carbon porous plate by capillary force and vaporized on a surface at a side of the fuel electrode of the carbon porous plate.

However, in the related art of the above-mentioned Japan Laid-Open Patent Application Publication No. 2000-106201, since the capillary force is used, transferring speed in the carbon porous plate is slow. Hence, in a case where a high power discharge capability for the portable type electronic device of the methanol aqueous solution is implemented, reaction unevenness is generated at the fuel electrode due to lack of the supply of methanol so that the amount of the electric power generated and efficiency of the electric power generation may be reduced. In addition, in order to control the transferring speed of the methanol aqueous solution in the carbon porous plate, a carbon porous plate having a structure where the diameter of the pores is controlled is required and the manufacturing of such a carbon porous plate is not easy.

### SUMMARY OF THE INVENTION

Accordingly, it is a general object of the present invention to provide a novel and useful fuel cell.

Another and more specific object of the present invention is to provide a vaporized fuel supply type fuel cell wherein fuel supply speed can be controlled under a simple structure.

The above object of the present invention is achieved by a fuel cell, including:

an electric power generation part;

the electric power generation part including

an air electrode to which oxygen gas is supplied,

a fuel electrode to which fuel gas is supplied, and

a solid electrolyte layer having a proton conductivity and put between the air electrode and fuel electrode;

a fuel storage part storing a liquid fuel;

a liquid fuel vaporization film made of non-porous material and configured to vaporize the liquid fuel so as to supply fuel gas to the fuel electrode; and

a gas fuel supply speed control plate provided between the liquid fuel vaporization film and the fuel electrode and configured to control a supply speed of the fuel gas to the fuel electrode;

wherein the gas fuel supply speed control plate includes a plurality of openings piercing between the liquid fuel vaporization film and the fuel electrode.

According to the above-mentioned fuel cell, the control plate, having plural openings piercing between the fuel electrode and the liquid fuel vaporization film made of non-porous material and configured to vaporize the liquid fuel and supply the fuel gas to the fuel electrode, is provided between the liquid fuel vaporization film and the fuel electrode. By forming the plural openings in the control plate, it is possible to control the supply speed of the fuel gas. Therefore, it is possible to provide a fuel cell with a simple structure whereby the fuel supply speed can be controlled.

In the fuel cell, the supply speed of the fuel gas to the fuel electrode may be controlled based on a numerical aperture of the control plate.

According to the above-mentioned fuel cell, it is possible to control the amount of the fuel gas passing through the opening by changing the numerical aperture (%) of the control plate, that is the whole area of the opening part/an area of the control plate×100 (%). As a result of this, it is possible to control the supply speed of the fuel gas to the fuel electrode.

The fuel cell may further include:

another control plate provided at a side of the fuel storage part of the liquid fuel vaporization film, the other control plate making contact with the liquid fuel vaporization film, the other control plate having a plurality of other openings piercing between the fuel storage part and the liquid fuel vaporization film.

According to the above-mentioned fuel cell, it is possible to control the supply speed of the fuel gas to the liquid fuel vaporization film by providing the above-mentioned control plate. As a result of this, it is possible to control the supply speed of the fuel gas to the fuel electrode in a wider range.

In the fuel cell, the supply speed of the liquid fuel to the liquid fuel vaporization film may be controlled based on a numerical aperture of the other control plate.

According to the above-mentioned fuel cell, it is possible to control the permeation speed of the fuel gas permeating the liquid fuel vaporization film. As a result of this, it is possible to control the supply speed of the fuel gas to the fuel electrode in a wider range.

Other objects, features, and advantages of the present invention will be come more apparent from the following detailed description when read in conjunction with the accompanying drawings.

### BRIEF DESCRIPTION OF THE DRAWINGS

FIG. 1 is a cross-sectional view of a fuel cell of a first embodiment of the present invention;

FIG. 2 is a cross-sectional view of the fuel cell for explaining control of methanol gas supply speed;

FIG. 3 is a schematic diagram of the fuel cell for explaining the control of the methanol gas supply speed;

FIG. 4 is a cross-sectional view of a fuel cell of a second embodiment of the present invention; and

FIG. 5 is a table showing methanol gas supply speed of a third embodiment and a comparison example.

### DETAILED DESCRIPTION OF THE PREFERED EMBODIMENTS

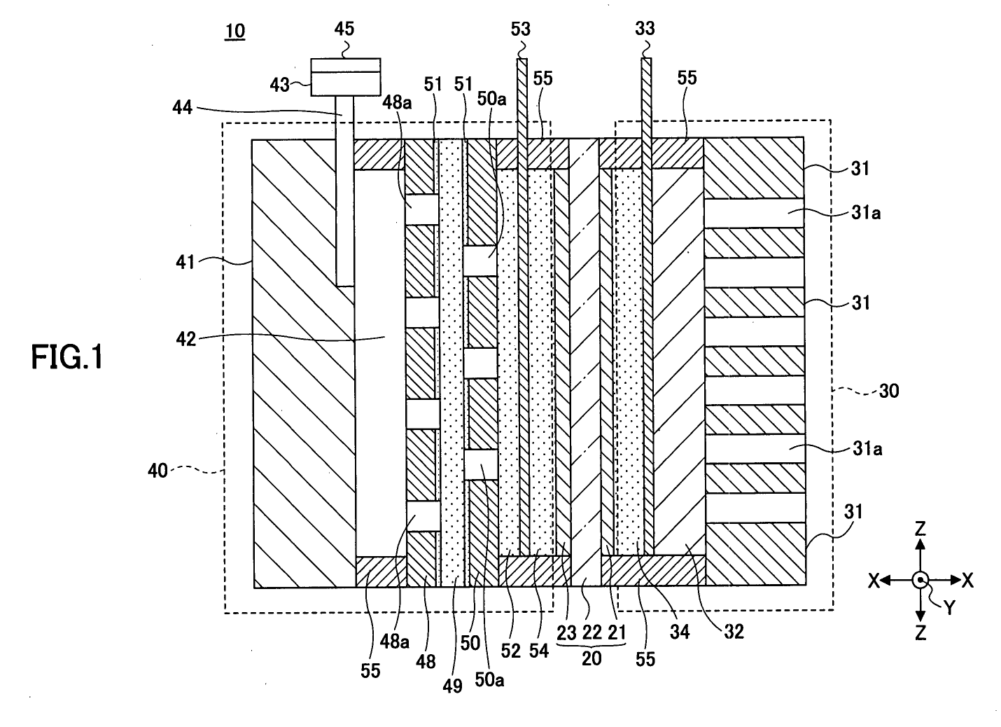

A description is given below, with reference to the FIG. 1 through FIG. 5 of embodiments of the present invention.

[First Embodiment]

FIG. 1 is a cross-sectional view of a fuel cell of a first embodiment of the present invention.

Referring to FIG. 1, a fuel cell 10 includes an electric generation part 20, an air supply part 30, a fuel supply part 40 and others. The air supply part 30 supplies oxygen gas included in air to the electric generation part 20. The fuel supply part 40 vaporizes liquid fuel so as to supply fuel gas such as methanol gas or the like to the electric generation part 20.

The electric generation part 20 has a structure where an air electrode 21, a solid electrolyte layer 22, and a fuel electrode 23 are stacked in this order. Since the air electrode 21 is a thin film, the illustration of the air electrode 21 is omitted. The air electrode 21 includes, for example, a porous carbon paper and a catalyst layer.

The catalyst layer includes, for example, Pt (platinum) fine particle or a carbon powder wherein Pt is carried on a surface of the carbon powder. Such a catalyst layer is provided so as to come in contact with the solid electrolyte layer 22.

The solid electrolyte layer 22 is formed by a proton conductive polymer solid electrolyte. Resin having a strong acid group such as a phosphoric acid, sulfone group, or the like or a weak acid group such as carboxyl group or the like is an example of a polymer solid electrolyte. It is possible to use, for example, NAFION (trademark) NF117 (product name of Dupont) or ACIPLEX (product name of Asahi-Kasei) as the solid electrolyte layer 22.

Since the fuel electrode 23 is a thin film, the illustration of the fuel electrode 23 is omitted. The fuel electrode 23 includes, for example, a porous carbon paper and a catalyst layer. The catalyst layer is formed by, for example, fine particles of Pt—Ru (ruthenium) alloy or a carbon powder wherein the Pt—Ru alloy is carried on the surface of the powder. Such a catalyst layer is provided so as to come in contact with the solid electrolyte layer 22.

In the electric generation part 20, fuel gas is supplied to the fuel electrode 23. As liquid fuel being the base of the fuel gas, for example, dimethyl ether, ethanol, methanol having substantially 100% density or aqueous solutions of them can be used. In the first and second embodiments, a methanol aqueous solution is used as an example.

In the catalyst layer of the fuel electrode 23, a reaction of the following reaction formula 1 proceeds. As a result of this, water vapor and methanol gas being fuel gas are consumed and carbon dioxide gas, protons (H⁺), electron (e⁻), and methyl formate and dimethoxymethane as sub-products are generated. In the catalyst layer, oxidation reaction of methyl formate and dimethoxymethane which reaction is different from the reaction of the following reaction formula 1 proceeds so that proton and electron are generated.
CH₃OH+H₂O→CO₂+6H⁺+6e⁻ [Reaction formula 1]

The protons pass through the solid electrolyte layer 22 and reach to the air electrode 21. The electrons work for a load connected to the fuel cell 10 as an outside circuit (not shown in FIG. 1) via a fuel gas diffusion layer 54 and a fuel electrode current collector 53.

In addition, the electron reach to the air electrode 21 via an air electrode current collector 33 and an air electrode gas diffusion layer 34.

In the catalyst layer of the air electrode 21, a reaction of the following reaction formula 2 proceeds. As a result of this, protons, electron and oxygen gas are consumed and water vapor is generated.
3/2O₂+6H⁺+6e⁻→3H₂O [Reaction formula 2]

The generated water vapor is discharged to the outside via the air electrode gas diffusion layers 32 and 34 and an oxygen supply opening 31a. Furthermore, carbon dioxide gas generated at the fuel electrode 23 is discharged to the outside via a generation gas discharge part not shown in FIG. 1.

Thus, the fuel cell 10 generates electricity by using the methanol aqueous solution as liquid fuel.

The air supply part 30 includes an air electrode housing 31, the air electrode gas diffusion layers 32 and 34, and the air electrode current collector 33. By the air electrode gas diffusion layers 32 and 34, oxygen gas led from the oxygen supply opening 31a of the air electrode side housing 31 is diffused and is led to the air electrode 21.

The air electrode side housing 31 is formed by a metal material or a resin material. Although there is no limitation as the resin material, it is preferable to use resin of the polyolefin group such as polypropylene or polyethylene, fluorine resin such as PTFE (polytetrafluoroethylene) or PFA, polyvinyl chloride, poly butylene terephthalate (PBT), polyethylene naphthalate (PEN), polyethersulfone (PES), polysulfone, poly phenylene oxide (PPO), polyetheretherketone, acrylic, or the like, as the above-mentioned resin material from the perspective of durability with alcohol such as methanol.

A large number of the oxygen supply openings 31a piercing the air electrode side housing 31 are provided in the air electrode side housing 31. It is preferable that the oxygen supply openings 31a be provided so that the oxygen gas is evenly led to the entirely of the air electrode gas diffusion layer 32.

The air electrode gas diffusion layer 32 is formed by a porous material. Although there is no limitation as the porous material, it is preferable to use, for example, a ceramic porous body, a carbon paper, a carbon bonded-fiber fabric, a fluoride resin porous body, a polypropylene porous body, or the like.

The air electrode current collector 33 has conductivity. The air electrode current collector 33 also has a mesh or porous structure. The air electrode current collector 33 makes oxygen gas permeate from a side of the air electrode gas diffusion layer 32 to a side of the air electrode gas diffusion layer 34.

It is preferable that the air electrode current collector 33 be made of a metal material having a high resistance to corrosion such as Ni, SUS304, SUS316, or the like. The air electrode current collector 33 may have a structure of, for example, a metal mesh, expanded metal, a metal bonded-fiber fabric, or a foam metal having a three dimensional network structure.

In addition, it is preferable that a metal film having a high conductivity and high resistance to corrosion, such as Au film or Au alloy film, be formed on a surface of the air electrode current collector 33. By providing such a metal film, it is possible to improve the resistance to corrosion of the air electrode current collector 33 and reduce contact resistance with the air electrode gas diffusion layer 34.

The air electrode gas diffusion layer 34 is formed by a conductive porous material. As the conductive porous material, a carbon paper, a carbon bonded-fiber fabric, or the like can be used.

In the air supply part 30, oxygen gas in the air is led from the oxygen supply opening 31a of the air electrode side housing 31. The oxygen gas is diffused via opening parts of the air electrode gas diffusion layers 32 and 34 or a pore so as to be evenly led on the surface of the air electrode 21.

If oxygen gas can be supplied sufficiently diffused on the surface of the air electrode 21 without the air electrode gas diffusion layer 32 and/or the air electrode gas diffusion layer 34, the air electrode gas diffusion layers 32 and 34 are not required to be provided.

A sealing material 55 is made of resin having good sealability such as, for example, epoxy resin or olefin group resin. The sealing material 55 prevents carbon monoxide gas or methanol gas in the fuel cell 10 or liquid such as the methanol aqueous solution from leaking to the outside of the fuel cell 10. In addition, the sealing material 55 is used for a fuel supply part 40 discussed below in the same way as the above-mentioned way.

The fuel supply part 40 includes a fuel electrode side housing 41, a fuel storage part 42, a liquid fuel vaporization film 49, fuel gas diffusion layers 52 and 54, the fuel electrode current collector 53, and others. The methanol aqueous solution is received in the fuel storage part 42. Methanol in the methanol aqueous solution is vaporized so as to change to methanol gas by the liquid fuel vaporization film 49. The methanol gas is diffused and led in the fuel electrode 23 by the fuel gas diffusion layers 52 and 54.

In addition, the fuel supply part 40 includes a first control plate 48 provided at a side of the fuel storage part 42 of the liquid fuel vaporization film 49 and a second control plate 50 at a side of the fuel gas diffusion layer 52 of the liquid fuel vaporization film 49, so that the supply speed of the methanol gas can be controlled.

The fuel electrode side housing 41 is formed by a metal material or a resin material. Although there is no limitation as the resin material, it is preferable to select it from the resin material similar or the same as the material used for the above-mentioned air electrode side housing 31, from the perspective of durability with alcohol such as methanol.

The fuel storage part 42 is a space forming part put between the fuel electrode side housing 41 and the first control plate 48. The methanol aqueous solution is supplied from a fuel cartridge 43 to the fuel storage part 42 via the fuel supply opening 44. The methanol aqueous solution in the fuel storage part 42 comes in contact with the surface of the liquid fuel vaporization film 49 via the surface of the first control plate 48 and an opening part 48a.

The fuel cartridge 43 stores the methanol aqueous solution and supplies methanol aqueous solution to the fuel storage part 42. Although there is no limitation as a supply driving source of the methanol aqueous solution, for example, a pump (not shown in FIG. 1), a pressure applying part 45 discussed below, or the combination of the pump and the pressure applying part 45 can be used. A valve may be provided at the fuel supply opening 44 so as to control an inflow or back-flow of the methanol aqueous solution.

The pressure applying part 45 is provided at the fuel cartridge part 43. The pressure applying part 45 applies a back pressure to the methanol aqueous solution, so that the vaporization speed of the methanol in the liquid fuel vaporization film 49 can be improved and the supply speed of the methanol gas can be increased.

The pressure applying part 45 applies, directly or via gas such as nitrogen gas, the back pressure to the methanol aqueous solution filling the fuel cartridge 43. The amount of the back pressure is properly selected based on the material of the liquid fuel vaporization film 49. It is preferable that the amount of back pressure be in the range 10 kPa-100 kPa.

The pressure applying part 45 may be directly connected to the fuel storage part 42 so as to directly apply the back pressure to the methanol aqueous solution filling the fuel storage part 42. In this case, a valve or the like is provided so as to prevent the back-flow of the methanol to the fuel cartridge 43.

Furthermore, in a case where the methanol aqueous solution is sufficiently supplied to the liquid fuel vaporization film 49, the pressure applying part 45 may not be required.

Details of the first control plate 48, the liquid fuel vaporization film 49 and the second control plate 50 are discussed below. In a simple structure, methanol aqueous solution can be changed to methanol gas and the methanol supply speed to the fuel electrode 23 can be controlled.

The fuel gas diffusion layer 52 is formed by a porous material having durability with alcohol such as methanol. Ceramic, a carbon paper, a carbon bonded-fiber fabric, a fluoride resin, polypropylene, or the like may be used as a porous material proper for the fuel gas diffusion layer 52.

The range between 30% and 95% is desirable as the porosity of the fuel gas diffusion layer 52. The range 40% through 90% is more desirable as the porosity of the fuel gas diffusion layer 52. If the porosity exceeds 95%, the mechanical strength of the fuel gas diffusion layer 52 is degraded.

Although there is no limitation regarding the thickness of the fuel gas diffusion layer 52, it is preferable that the fuel gas diffusion layer 52 have a thickness equal to or less than 1 mm. If the thickness of the fuel gas diffusion layer 52 exceeds 1 mm, the fuel cell will be too thick.

Although it is preferable to provide the fuel gas diffusion layer 52, the fuel gas diffusion layer is not required if the diffusion of the fuel gas is sufficient.

It is preferable that the fuel electrode current collector 53 be made of the same material as the material of the air electrode current collector 33 and a metal film having a high conductivity and high resistance to corrosion, such as Au film, is formed on a surface of the fuel electrode current collector 53.

The fuel gas diffusion layer 54 is formed by a conductive porous material having durability with alcohol such as methanol. As the conductive porous material, a carbon paper, a carbon bonded-fiber fabric, or the like can be used.

As discussed above, the fuel supply part 40 vaporizes the methanol aqueous solution supplied to the fuel storage part 42 by the liquid fuel vaporization film 49 and supplies the methanol gas to the fuel electrode 23. Based on the reaction of the above-mentioned reaction formula 1, the electrons and protons are generated.

Next, details of the first control plate 48, the liquid fuel vaporization film 49 and the second control plate 50 are discussed.

The liquid fuel vaporization film 49 is formed by a non-porous material of a polymer having durability with alcohol such as methanol. By using such a non-porous material of the polymer, the methanol in the liquid is sufficiently vaporized and the methanol gas permeates at a sufficient permeating speed in the liquid fuel vaporization film 49. Hence, it is possible to sufficiently secure the supply speed of the methanol gas to the fuel electrode 23.

Perfluoro sulfonic acid group resin is used as a proper non-porous material for the liquid fuel vaporization film 49. The perfluoro sulfonic acid group resin has, for example, a fluoride resin main chain and a side chain having a sulfonic acid group. For example, NAFION (trademark) manufactured by Dupont or ACIPLEX (product name of Asahi-Kasei) can be used as a resin film of such a material.

A resin whose main material is a perfluoro carbon group including carboxyl is also used as the proper non-porous material for the liquid fuel vaporization film 49. The resin of the perfluoro carbon group including carboxyl has, for example, a fluoride resin main chain and a side chain having a carboxyl group. For example, FLEMION manufactured by Asahi-Kasei can be used as the resin of such a material.

In addition, a resin whose main material is selected from polysulfone, polyimide, polyetheretherketone and polyamide is also used as the proper non-porous material for the liquid fuel vaporization film 49.

Furthermore, a polymer material including silicon such as silicon rubber is also used as the proper non-porous material for the liquid fuel vaporization film 49.

Here, resin in which the above-mentioned designated resins are equal to or greater than 50 weight % of the entire resin is included.

In the above-discussed non-porous material, the resin whose main material is perfluoro sulfonic acid group resin and the perfluoro carbon group resin including carboxyl provide permeation speed of the methanol gas (fuel gas) greater than other materials. More specifically, it is possible to obtain effective permeation speed of the methanol gas (fuel gas) by the first control plate 48 and the second control plate 50.

Plural opening parts 48a configured to pierce the first control plate 48 in a plate thickness direction are formed in the first control plate 48. The opening parts 48a are formed, for example, along a Y axis direction and a Z axis direction with a designated distance.

The supply speed of the methanol aqueous solution to the liquid fuel vaporization film 49 depends on an area where the liquid fuel vaporization film 49 comes in contact with the methanol aqueous solution. Therefore, the supply speed of the methanol aqueous solution to the liquid fuel vaporization film 49 can be controlled by changing the entire area of the openings 48a of the first control plate 48, namely by changing a numerical aperture of the first control plate which equals to “(entire area of the openings 48a)/(the area of the first control plate 48)×100”.

In addition, plural opening parts 50a configured to pierce the second control plate 50 in a plate thickness direction are formed in the second control plate 50. The opening parts 50a are formed, for example, along a Y axis direction and a Z axis direction with a designated distance.

The supply speed of the methanol gas to the fuel electrode 23 depends on the entire area of the openings 50a of the second control plate 50, namely a numerical aperture of the second control plate 50. Therefore, the supply speed of the methanol gas to the fuel electrode 23 can be controlled by changing the numerical aperture of the second control plate 50.

The numerical apertures of the first control plate 48 and the second control plate 50 are properly set based on a permeating speed of the methanol gas of the liquid fuel vaporization film 49 or a distance between the opening part 48a of the first control plate 48 and the opening part 50a of the second control plate 50.

However, it is preferable to set the numerical apertures in a range equal to or less than 50% from the perspective of sufficient mechanical strengths of the first control plate 48 and the second control plate 50. There is no lower limitation of the numerical apertures of the first control plate 48 and the second control plate 50. However, the numerical aperture at which at least the methanol or the methanol gas permeates, a numerical aperture greater than 0% for example, is set.

There is no limitation of configurations of the opening parts 48a and 50a. For example, the configurations may be circular including elliptic, triangular, rectangular, or slit-shape extending in a single direction. In a case where the opening parts 48a and 50a have circular-shaped configurations, the diameters of the opening parts 48a and 50a may be, for example, 10 μm through 10 mm.

There is no limitation of material forming the first control plate 48 and the second control plate 50 as long as the material has a plane plate shaped configuration and durability with alcohol such as methanol. However, a metal plate, a ceramic plate or a plastic plate can be used for the first control plate 48 and the second control plate 50. It is preferable to use a metal plate for the first control plate 48 and the second control plate 50 because the metal plate has sufficient mechanical strength and it is easy to form holes, namely openings 48a and 50a.

Adhesive layers 51 are formed between the first control plate 48 and the liquid fuel vaporization film 49 and between the second control plate 50 and the liquid fuel vaporization film 49. The adhesive layers 51 fix the surface of the liquid fuel vaporization film 49 to the first control plate 48 and the second control plate 50 so that the liquid fuel vaporization film 49, the first control plate 48, and the second control plate 50 are in a body. As a result of this, volume change of the liquid fuel vaporization film 49 can be prevented so that breaking off due to volume change of the liquid fuel vaporization film 49 can be controlled.

More specifically, if the liquid fuel vaporization film 40 is wetted by the methanol aqueous solution, the liquid fuel vaporization film 40 swells. If supply of the methanol aqueous solution is stopped, the liquid fuel vaporization film 40 dries and contracts. If such a volume change is repeated, the liquid fuel vaporization film 49 is broken off so that the methanol aqueous solution leaks to the fuel electrode side and the amount of electric generation is reduced.

On the other hand, by providing the liquid fuel vaporization film 49 by using the adhesive layer 51, it is possible to prevent the liquid fuel vaporization film 49 from being broken off so that it is possible to make the service life of the fuel cell 10 long. Providing the adhesive layer 51 is effective especially when the liquid fuel vaporization film 49 is made of resin whose main material is resin of the perfluoro sulfonic acid group or perfluoro carbon group including carboxyl.

The adhesive layers 51 are provided at parts where the liquid fuel vaporization films 49 come in contact with the first control plate 48 and the second control plate 50. No adhesive layer 51 is provided at a part exposed by the opening 48a and the opening 50a of the liquid fuel vaporization film 49.

There is no limitation of the material of the adhesive layer 51 as long as the liquid fuel vaporization film 49 can be adhered to the first control plate 48 and the second control plate 50 by the adhesion layer 51. As the adhesive, for example, a silicon group adhesive, an epoxy group adhesive, a cyanoacrylate group adhesive, and a urethane group adhesive can be used.

In a case where the liquid fuel vaporization film 49 is made of the resin of the perfluoro sulfonic acid group, for example, it is preferable to use the silicon group adhesive as the adhesive. Furthermore, it is preferable to apply a silane coupling agent on a surface of the silicon group adhesive and make the resin of the perfluoro sulfonic acid group come in contact with the silane coupling agent so that a strong fixing can be obtained.

Instead of providing the adhesive layer 51, an engaging member such as a screw (not shown) may be used so that the first control plate 48 and the second control plate 50 between which the liquid fuel vaporization film is put are engaged. As a result of this, the volume change of the liquid fuel vaporization film 49 can be prevented.

In addition, as discussed below, it is possible to control the supply speed of the methanol gas to the fuel electrode 23 by making positions of the opening parts 48a of the first control plate 48 and the opening parts 50a of the second control plate 50 different.

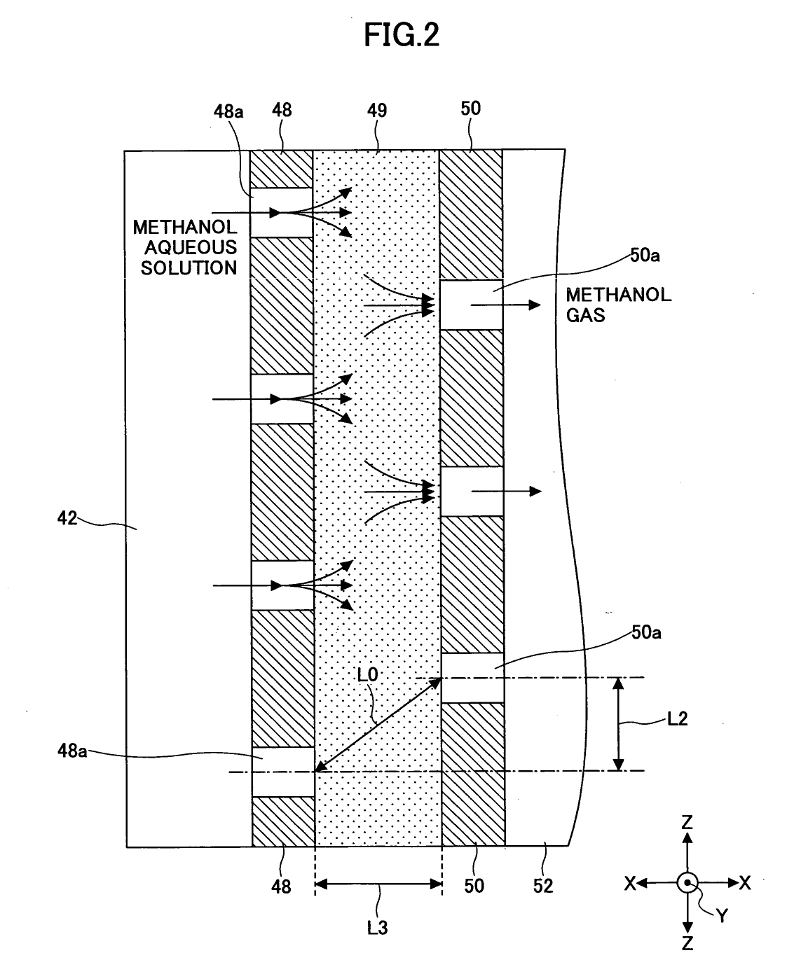

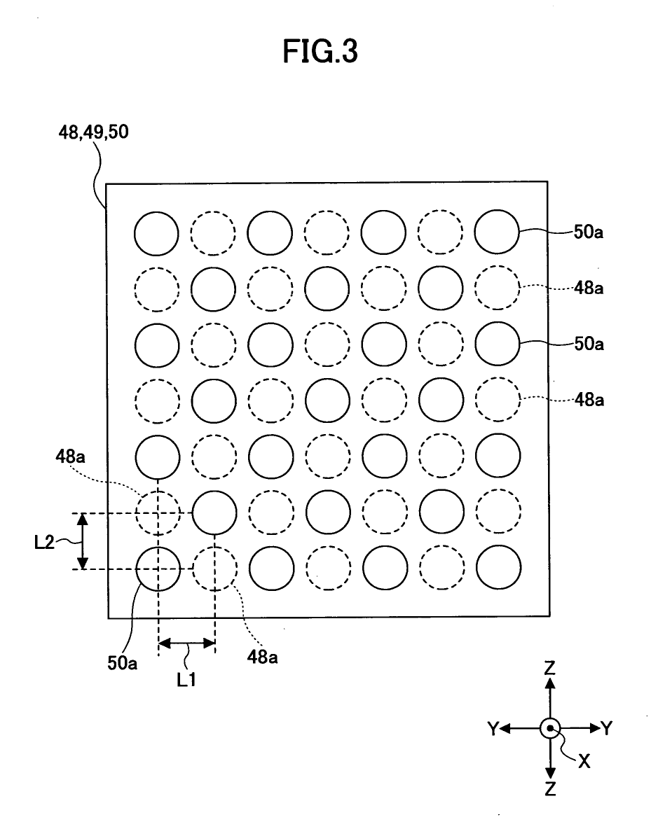

FIG. 2 is a cross-sectional view of the fuel cell for explaining a control of a methanol gas supply speed. FIG. 3 is a schematic diagram of the fuel cell for explaining the control of the methanol gas supply speed.

In FIG. 2, while the illustration of the adhesive layer 51 is omitted, the fuel storage part 42, the first control plate 48, the fuel vaporization film 49, and the second control plate 50 are shown. In FIG. 3, the opening parts 50a of the second control plate 50 are shown by solid line and the opening part 48a of the first control plate 48 are shown by dotted lines. In the examples shown in FIG. 2 and FIG. 3, the opening parts 48a and 50a have circular-shaped configurations as examples.

Referring to FIG. 2 and FIG. 3, the opening parts 48a of the first control plate 48 are separated from the corresponding closest opening parts 50a of the second control plate 50 via the liquid fuel vaporization film 49 by a designated length L0. In this case, the methanol aqueous solution permeating from the opening parts 48a of the first control plate 48 to the liquid fuel vaporization film 49 permeates and is vaporized in the liquid fuel vaporization film 49 so that the methanol gas is mainly discharged from the opening parts 50a of the second control plate 50 being separated from the opening parts 48a of the first control plate 48 with the shortest distance L0.

Here, the distance L0 is between the center of the opening part 48a in the surface at a side of the first control plate 48 of the liquid fuel vaporization film 49 and the center of the corresponding closest opening part 50a in the surface at a side of the second control plate 50 of the liquid fuel vaporization film 49. The distance L0 is determined by a gap L1 in a Y-axis direction between the opening part 48a and the opening part 50a, a gap L2 in a Z-axis direction between the opening part 48a and the opening part 50a, and a thickness L3 of the liquid fuel vaporization film 49 in an X-axis direction.

The time period from when the methanol aqueous solution permeates the liquid fuel vaporization film 49 to the time when the methanol aqueous solution is discharged as methanol gas depends on the length L0.

In order words, as the length L0 is shorter, the time period during which the methanol gas having a unit volume permeates is short and the supply speed of the methanol gas increases. As the length L0 is longer, the time period during which the methanol gas having a unit volume permeates is long and the supply speed of the methanol gas decreases. Therefore, it is possible to control the supply speed of the methanol gas by changing the length L0.

In addition, in a case where the supply speed of the methanol gas needs to be decreased, it is preferable to increase the gaps L1 and L2 between the opening part 48a and the opening part 50a, rather than to increase the thickness L3. Because of this, it is possible to decrease the supply speed of the methanol gas without increasing the volume of the fuel cell 10 and to change the supply speed of the methanol gas in a wider range. Furthermore, it is possible to set a desirable supply speed of the methanol gas and make the fuel cell 10 thin in an X axis direction.

In a case where the supply speed of the methanol gas needs to be increased, the gaps L1 and L2 between the opening part 48a and the opening part 50a may be made small or zero. In addition, in this case, the methanol aqueous solution may be pressured by the pressure applying part 45.

Furthermore, the numerical aperture of the first control plate 48 and the numerical aperture of the second control plate 50 may be different so that the supply speed of the methanol gas can be controlled. By combining the numerical apertures of the first control plate 48 and the second control plate 50, the gaps L1 and L2, and the thickness L3, the supply speed of the methanol gas can be controlled.

According to the first embodiment of the present invention, the liquid fuel vaporization film 49 is provided between the fuel storage part 42 of the fuel supply part 40 and the fuel gas diffusion layer 52. At corresponding sides of the liquid fuel vaporization film 49, the first control plate 48 having plural opening parts 48a and the second control plate 50 having plural opening parts 50a are arranged. The supply speed of the methanol gas to the fuel electrode 23 can be controlled by setting the numerical apertures of the control plates 48 and 50 and relative position of the opening parts 48a and 50a.

### FIRST EXAMPLE AND SECOND EXAMPLE

In the first and second example, the fuel cell has the substantially same structure as the fuel cell shown in FIG. 1 through FIG. 3. In the following explanation, FIG. 1 through FIG. 3 are referred to.

First, a structure common to both the first and second examples is discussed. Materials discussed below are used for the fuel cells in the first example and the second example.

[Electric Generation Part]

An area of the electric generation part is 20 cm². Pt—Ru alloy carrying catalyst TEC61E54 made by Tanaka Kikinzoku Company is used for a catalyst layer of the fuel electrode 23. Pt carrying catalyst TEC10E50E is used for a catalyst layer of the air electrode 21. NAFION (trademark) NH117 (product name of Dupont) is used for the solid electrolyte layer 22.

The carbon paper having a thickness of 280 μm and manufactured by Toray Company is used for the air electrode gas diffusion layers 32 and 34. SUS 304 having a mesh structure is used for the air electrode current collector 33.

[Fuel Supply Part]

NAFION (trademark) NH117 (product name of Dupont) is used for the liquid fuel vaporization film 49. The carbon paper having a thickness of 280 μm and manufactured by Toray Company is used for the fuel gas diffusion layers 52 and 54. SUS304 having a mesh structure is used for the fuel electrode current collector 53.

SUS 316 is used for the first control plate 48 and the second control plate 50. The opening parts 48a and 50a have diameters in a range 1.2 mm through 1.5 mm. A silicon adhesive and a silane coupling adhesive are used as the adhesive layer 51.

Next, differences of structures between the first and second examples are discussed.

In the first example, the gaps between the opening part 48a of the first control plate 48 and the corresponding opening part 50a of the second control plate 50, namely L1 and L2 shown in FIG. 3, are 0.25 mm and the intervals in Y-axis and Z-axis directions between the opening part 48a of the first control plate 48 and the opening part 50a of the second control plate 50 are 3 mm.

In the second example, the gaps between the opening parts 48a of the first control plate 48 and the corresponding opening parts 50a of the second control plate 50, namely L1 and L2 shown in FIG. 3, are set 0.20 mm and the intervals in Y-axis and Z-axis directions between the opening parts 48a of the first control plate 48 and the opening parts 50a of the second control plate 50 are set 3 mm.

The numerical apertures of the first control plate 48 and the second control plate 50 in the first example are the same as the numerical apertures of the first control plate 48 and the second control plate 50 in the second example. Here, the numerical aperture of the control plate is expressed as “a whole area of the opening part/an area of the control plate×100”(%)

Next, a constant voltage discharge property test (voltage of 0.3 V) for the first and second examples are implemented. Methanol having a 100% density is used as the liquid fuel. The constant voltage discharge property of the first example shows an electrical current value of 0.39 and the constant voltage discharge property of the second example shows an electrical current value of 0.68.

The second example obtains a larger discharge electrical current than the first example in which the gap between the opening parts 48a of the first control plate 48 and the opening parts 50a of the second control plate 50 is smaller than the first example. Such a difference of the electrical current value, namely the amount of the electrical generation, is caused by the difference of the supply amount of the methanol gas.

Thus, it can be found that the supply speed of the methanol gas can be controlled based on the gap between the opening parts 48a of the first control plate 48 and the opening parts 50a of the second control plate 50. Here, the electric current value is indicated as a relative value.

[Second Embodiment]

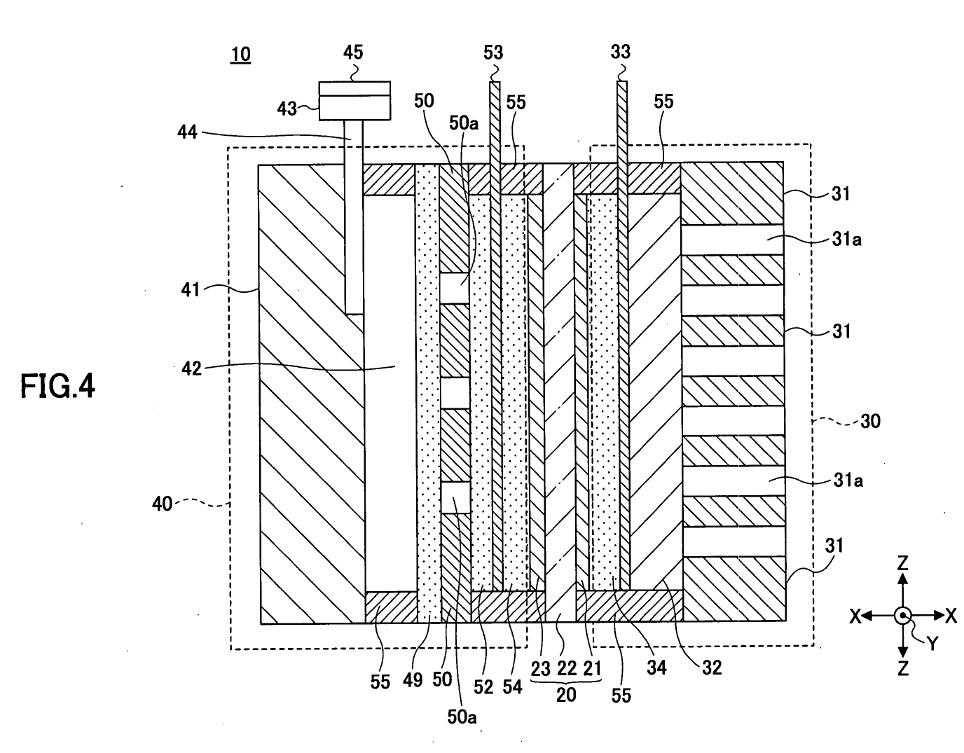

A fuel cell of the second embodiment of the present invention is a modified example of the fuel cell of the first embodiment of the present invention. Here, FIG. 4 is a cross-sectional view of a fuel cell of a second embodiment of the present invention. In FIG. 4, parts that are the same as the parts shown in FIG. 1 through FIG. 3 are given the same reference numerals, and explanation thereof is omitted.

Referring to FIG. 4, the fuel cell 60 of the second embodiment of the present invention has the same structure as the fuel cell 10 of the first embodiment of the present invention as shown in FIG. 1.

In the fuel cell 60 as well as the fuel cell 10 shown in FIG. 1, the second control plate 50 has a structure where plural openings 50a are formed at a side of the fuel electrode 23 of the liquid fuel vaporization film 49.

As discussed in the first embodiment of the present invention, the supply speed of the methanol gas to the fuel electrode 23 can be controlled by controlling a ratio of the entire areas of the opening parts 50a to the area of the second control plate 50, namely the numerical aperture. The range in which the supply speed of the methanol gas can be controlled in this case is narrower than the fuel cell of the first embodiment. However, since the fuel cell of this embodiment has a simpler structure than the fuel cell of the first embodiment, it is possible to achieve easy productivity, reduction of the manufacturing cost, and others.

According to this embodiment, in the second control plate 50, plural openings 50a are formed at the side of the fuel electrode 23 of the liquid fuel vaporization film 49. In addition, the supply speed of the methanol gas to the fuel electrode 23 can be controlled based on the numerical aperture of the second control plate 50.

The second control plate 50 may be provided so as to come in contact with the liquid fuel vaporization film 49 or be separated from the liquid fuel vaporization film 49. The second control plate 50 may be provided, for example, via a space or between the fuel gas diffusion layer 52 and the fuel electrode current collector 53. In either case, the supply speed of the methanol gas to the fuel electrode 23 can be controlled by the second control plate 50.

[Third Example]

In the third example, a structural body having the following modified structure of the fuel cell 60 shown in FIG. 4 is manufactured. That is, parts from the fuel gas diffusion layer 52 to the air supply part 30 are not provided. The fuel electrode side housing 41, the fuel storage part 42, the fuel cartridge 43, the fuel pressure part 45, the liquid fuel vaporization film 49, and the second control plate 50 are provided. A side of the fuel gas diffusion layer 52 of the second control plate 50 is exposed to outside air.

The fuel electrode side housing 41, the fuel storage part 42, the liquid fuel vaporization film 49, and the second control plate 50 have the same structure as the structure of the first example. As the second control plate 50, the structural body having the numerical aperture, that is “(entire area of the openings)/(the area of the control plate)×100” having a range of 50% through 90% is manufactured. In addition, for comparison, a structural body for the comparison example not using the second control plate 50 is manufactured.

Next, 10 cm³ of methanol (liquid) having an approximately 100% density is supplied from the fuel cartridge to the fuel storage part 42 and a back pressure of 100 kPa is applied by the fuel pressure part 45 so that methanol is vaporized from the second control plate 50. The change of the weight of methanol in the fuel storage part 42 is measured so as to be converted into the supply speed of methanol gas.

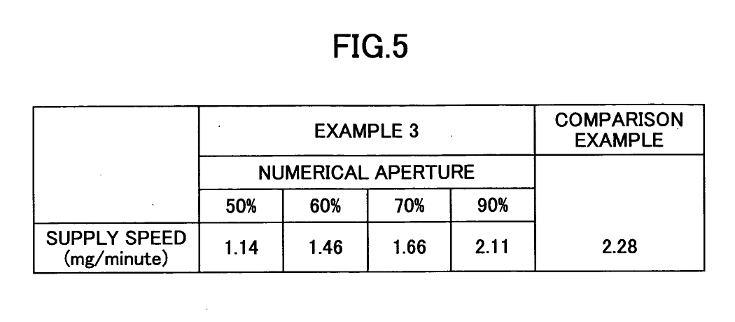

FIG. 5 is a table showing methanol gas supply speed of a third embodiment and a comparison example.

Referring to FIG. 5, in the third example, the supply speed of the methanol gas is in proportion to the numerical aperture of the second control plate 50. As compared with a comparison example where the second control plate 50 is not used, it is possible to decrease the supply of the methanol gas by decreasing the numerical aperture of the second control plate 50 in the third example and the controllability of the supply of the methanol gas is good.

The present invention is not limited to these embodiments, but variations and modifications may be made without departing from the scope of the present invention.

For example, a case where both the first control plate 48 and the second control plate 50 are provided as shown in FIG. 1 and a case where the second control plate 50 is provided as shown in FIG. 4 are discussed in the above first embodiment and second embodiment. However, only the first control plate 48 shown in FIG. 1 may be provided. In this case, since the supply speed of the methanol aqueous solution to the liquid fuel vaporization film 49 can be controlled, it is possible to control the supply speed of the methanol gas.

This patent application is based on Japanese Priority Patent Application No. 2005-313251 filed on Oct. 27, 2005, the entire contents of which are hereby incorporated by reference.

What is claimed is:

1. A fuel cell, comprising:
an electric power generation part;
the electric power generation part including
an air electrode to which oxygen gas is supplied,
a fuel electrode to which fuel gas is supplied, and
a solid electrolyte layer having a proton conductivity and put between the air electrode and fuel electrode;
a fuel storage part storing a liquid fuel;
a liquid fuel vaporization film made of non-porous material and configured to vaporize the liquid fuel so as to supply fuel gas to the fuel electrode; and
a gas fuel supply speed control plate provided between the liquid fuel vaporization film and the fuel electrode and configured to control a supply speed of the fuel gas to the fuel electrode;
wherein the gas fuel supply speed control plate includes a plurality of openings piercing between the liquid fuel vaporization film and the fuel electrode.

2. The fuel cell as claimed in claim 1,
wherein the supply speed of the fuel gas to the fuel electrode is controlled based on a numerical aperture of the control plate.

3. The fuel cell as claimed in claim 1,
wherein the control plate is provided so as to come in contact with the liquid vaporization film.

4. The fuel cell as claimed in claim 1, further comprising:
a pressure applying part configured to apply a pressure to the liquid fuel.

5. The fuel cell as claimed in claim 1, further comprising:
another control plate provided at a side of the fuel storage part of the liquid fuel vaporization film, the other control plate making contact with the liquid fuel vaporization film, the other control plate having a plurality of other openings piercing between the fuel storage part and the liquid fuel vaporization film.

6. The fuel cell as claimed in claim 5,
wherein the supply speed of the liquid fuel to the liquid fuel vaporization film is controlled based on a numerical aperture of the other control plate.

7. The fuel cell as claimed in claim 5,
wherein the opening and the other opening control the supply speed of the fuel gas to the fuel electrode based on a distance between positions contacting the liquid fuel vaporization film.

8. The fuel cell as claimed in claim 5,
wherein the opening and the other opening are formed at a designated gap; and
the supply speed of the fuel gas to the fuel electrode is based on a shortest distance between the opening and the other opening seen in a direction perpendicular to a surface of the liquid fuel vaporization film.

9. The fuel cell as claimed in claim 5,
wherein the liquid fuel vaporization film is made of resin whose main material is selected from a group consisting of perfluoro sulfonic acid group, perfluoro carbon group including carboxyl, polysulfone, polyimide, polyetheretherketone and polyamide, or a polymer material including silicon.

10. The fuel cell as claimed in claim 5,
wherein the control plate, the liquid fuel vaporization film and the other control plate are formed in a body.

11. The fuel cell as claimed in claim 10,
wherein an adhesion layer is provided between the control plate and the liquid fuel vaporization film and between the other control plate and the liquid fuel vaporization film.

12. The fuel cell as claimed in claim 10,
wherein an adhesion layer is made of an adhesive selected from a group consisting of a silicon group, an epoxy group, a cyanoacrylate group and urethane group.

13. The fuel cell as claimed in claim 10,
wherein the liquid fuel vaporization film is made of resin whose main material is of a perfluoro sulfonic acid group or a perfluoro carbon group including carboxyl.

14. A fuel cell, comprising:
an electric power generation part;
the electric power generation part including
an air electrode to which oxygen gas is supplied,
a fuel electrode to which fuel gas is supplied, and
a solid electrolyte layer having a proton conductivity and put between the air electrode and fuel electrode;
a fuel storage part storing a liquid fuel;
a liquid fuel vaporization film made of non-porous material and configured to vaporize the liquid fuel so as to supply fuel gas to the fuel electrode; and
means for controlling a supply speed of the fuel gas to the fuel electrode;
wherein the means for controlling is provided between the liquid fuel vaporization film and the fuel electrode; and
the means for controlling includes a plurality of openings piercing between the liquid fuel vaporization film and the fuel electrode.

15. A fuel cell, comprising:
an electric power generation part;
the electric power generation part including
an air electrode to which oxygen gas is supplied,
a fuel electrode to which fuel gas is supplied, and
a solid electrolyte layer having a proton conductivity and put between the air electrode and fuel electrode;
a fuel storage part storing a liquid fuel;
a liquid fuel vaporization film made of non-porous material and configured to vaporize the liquid fuel so as to supply fuel gas to the fuel electrode;
a control plate provided between the liquid fuel vaporization film and the fuel electrode, contacting the liquid vaporization film, and including a plurality of openings piercing between the liquid fuel vaporization film and the fuel electrode; and
another control plate provided between the fuel storage part and the liquid fuel vaporization film, contacting the liquid vaporization film, and including a plurality of openings piercing between the fuel storage part and the liquid fuel vaporization film;
wherein the opening and the other opening control the supply speed of the fuel gas to the fuel electrode based on a distance between positions contacting the liquid fuel vaporization film.
